(19) United States
(12) Patent Application Publication
(10) Pub. No.: US 2022/0107114 A1
(43) Pub. Date: Apr. 7, 2022

(54) INDUCTION FLUID HEATER

(71) Applicant: Gabriel Da Veiga, Miami, FL (US)

(72) Inventor: Gabriel Da Veiga, Miami, FL (US)

(21) Appl. No.: 17/494,775

(22) Filed: Oct. 5, 2021

Related U.S. Application Data
(60) Provisional application No. 63/087,787, filed on Oct. 5, 2020.

(51) Int. Cl. F24H 1/10; H05B 6/10

(52) U.S. Cl. CPC F24H 1/101; F24H 2250/08; H05B 6/108

(57) ABSTRACT

A fluid induction heating system includes a heating apparatus having an outer shell and an inner tube. The outer shell may be insulative while the inner tube may be conductive. A fluid chamber may be defined within the outer shell. The area between inner tube and the outer shell may be an outer portion of the fluid chamber, while the area within the inner tube may an inner portion of the fluid chamber. The heating system may also include an electrical system, including electrical wiring around or near the exterior of the outer shell. The heating system may be used in a variety of fluid heating situations, such as pools, heaters, desalination, and energy generation.

### CROSS REFERENCE TO RELATED APPLICATIONS

This application claims priority to U.S. Provisional Application No. 63/087,787 filed Oct. 5, 2020, the entire contents of which are herein incorporated by reference.

### FIELD OF THE DISCLOSURE

This disclosure relates generally to systems, devices, and methods of the induction heating of fluid.

### BACKGROUND

A variety of fluid heating devices have been developed for use with buildings in residential, commercial, and industrial environments. These devices can range from a typical water heater found in a residential home, to a swimming pool heater, to heaters used in the context of power generation. Generally speaking, fluid heaters employ a pump to propagate a fluid flow through a kind of heat transfer unit. For example, a pool heater would draw water from the pool to the heater where heat is transferred to the water from a gas-powered combustion chamber, and the heated water is returned to the pool.

Induction heating is one fluid heating principle that is still being developed. Induction heating utilizes electromagnetic induction to generate heat in electrically conductive material. In a typical induction heater, an alternating current is passed through copper coils to create an alternating magnetic field, which in turn generates an electric current within the conductive material thereby heating the conductive material. This may be referred to as Joule heating. A principal benefit of inductive heating is that it heats the conductive material without a heat source directly contacting the material.

One of the earliest induction heaters is disclosed in U.S. Pat. No. 2,407,562 to Lofgren. Lofgren disclosed an induction air heater consisting of a cylindrical drum like shell. Cold air flows down the drum along the outer shell and then back up through an inner shell. Coils are placed within the inner shell, which inductively heat two conductive heating elements concentrically positioned around the coils. Thus, a significant portion of the internal chamber is occupied by the wiring positioned within the two heating elements. Moreover, Lofgren is silent as to how electricity might be provided to the wires aside from “a suitable source of alternating current.” Thus, this early design disclosed in Lofgren has several limitations.

Later designs present structural inefficiencies or deficiencies. For example, the induction heaters disclosed in U.S. Pat. No. 4,579,080 to Martin et al. and U.S. Pub. No. 2010/0213190 to Bron et al. disclose multiple induction surfaces but place structural components, including circuitry, in what could otherwise be the fluid flow path thereby limiting the fluid flow of the heater. Other induction heaters, such as those disclosed in U.S. Pat. No. 5,523,550 to Kimura and U.S. Pub. No. 2016/0195301 to Gaspard, only disclose induction heaters which offer a single fluid flow path, which also limits the efficiency of these designs.

The embodiments disclosed herein address the inefficiencies and deficiencies of the previously known induction heaters, including those prior art inefficiencies and deficiencies specifically discussed herein as well as additional inefficiencies and deficiencies that would be apparent to persons of ordinary skill in the art. The entirety of the prior art disclosures referenced herein are incorporated by reference into this disclosure.

### SUMMARY OF THE DISCLOSURE

The following presents a simplified summary of this disclosure in order to provide a basic understanding of some aspects of the embodiments disclosed herein. This summary is not an extensive overview of all embodiments of the invention as claimed. It is intended to neither identify key or critical elements of the invention nor delineate the scope of the invention. Its sole purpose is to present some concepts disclosed in a simplified form as a prelude to the more detailed description that is presented later.

An embodiment of a fluid induction heating apparatus may include an outer shell and an inner tube. The interior of the outer shell may be defined a fluid chamber. The inner tube may be secured within the fluid chamber. The area between the inner tube and the outer shell may define an outer portion of the fluid chamber, and the area within the inner tube may define an inner portion of the fluid chamber. At least a portion of the inner tube may be composed of a conductive material.

An embodiment of a fluid induction heating system may include a disclosed embodiment of a fluid induction heating apparatus and an electrical system. The electrical system may include electrical provided outside the outer shell, and a power unit in electrical communication with the electrical wiring in order to provide an electrical charge through the electrical wiring.

### BRIEF DESCRIPTION OF THE FIGURES

FIG. 1 illustrates an embodiment of a fluid induction heating system.

FIG. 2 illustrates an embodiment of a fluid induction heating apparatus for use in embodiments of a fluid induction heating system.

FIG. 3 illustrates an exploded view of the fluid induction heating apparatus of FIG. 2.

FIG. 4 illustrates a cross sectional view of a fluid induction heating apparatus for use in embodiments of a fluid induction heating system.

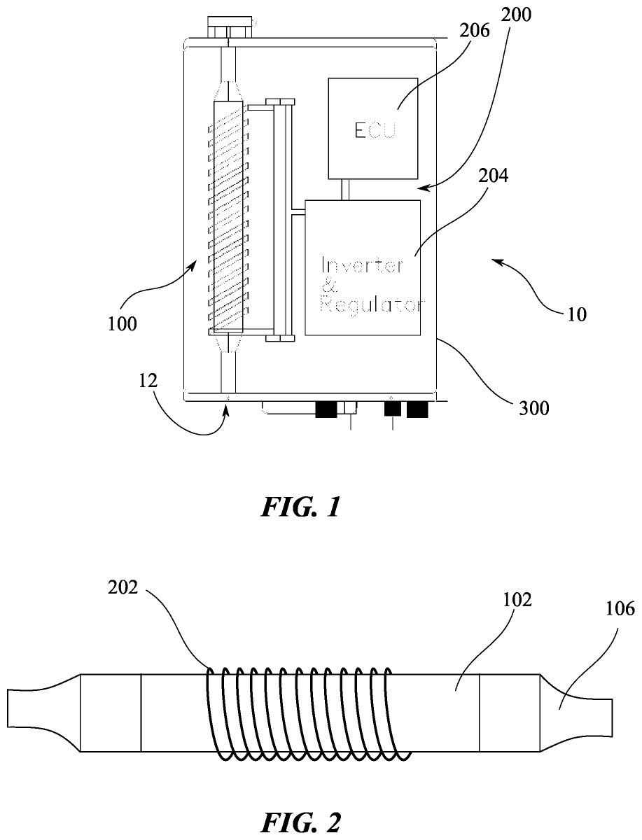

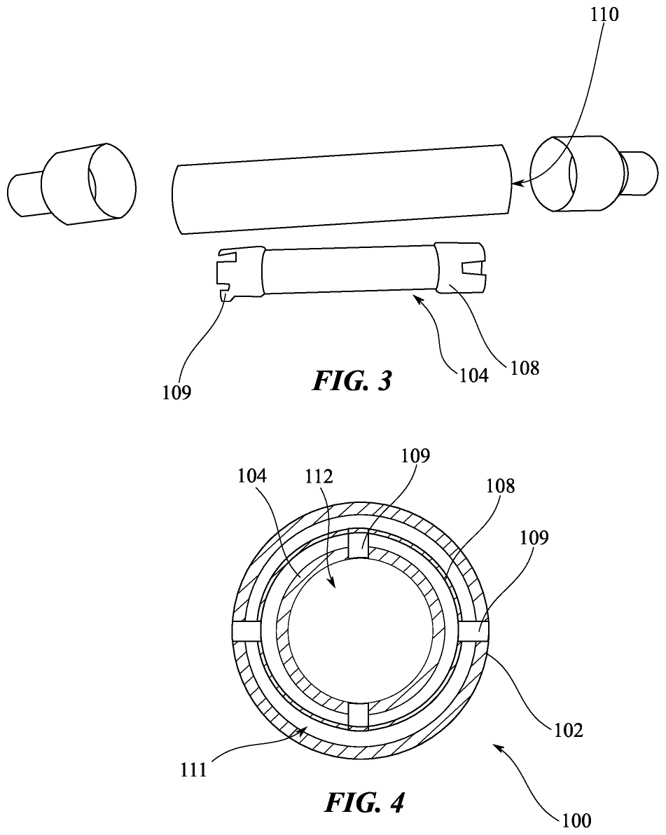

### DETAILED DESCRIPTION OF THE DISCLOSURE

The following detailed description and the appended drawings describe and illustrate some embodiments for the purpose of enabling one of ordinary skill in the relevant art to make use the invention. As such, the detailed description and illustration of these embodiments are purely illustrative in nature and are in no way intended to limit the scope of the invention, or its protection, in any manner. It should also be understood that the drawings are not necessarily to scale and in certain instances details may have been omitted, which are not necessary for an understanding of the disclosure, such as details of fabrication and assembly. In the accompanying drawings, like numerals represent like components.

An embodiment of a fluid induction heating apparatus may include an outer shell and an inner tube. The interior of the outer shell may be defined a fluid chamber. The inner tube may be secured within the fluid chamber. The area between the inner tube and the outer shell may define an outer portion of the fluid chamber, and the area within the inner tube may define an inner portion of the fluid chamber. At least a portion of the inner tube may be composed of a conductive material.

If further embodiments of a fluid induction heating apparatus, the apparatus may include a pair of connection caps each provided at a longitudinal end of the inner tube, each connection cap mutually connected with an inner surface of the outer shell as well as an outer surface of the inner tube. Each connection cap may include a plurality of wings, at least one wing of the plurality of wings is angled inwardly and connected with the inner tube, and at least one wing of the plurality of wings is angled outwardly and connected with the outer shell. The apparatus may include a pair of end caps each provided at a longitudinal end of the outer shell. The outer shell may be composed of an insulative material. The insulative material may be copper. The conductive material may be tungsten.

An embodiment of a fluid induction heating system may include a disclosed embodiment of a fluid induction heating apparatus and an electrical system. The electrical system may include electrical provided outside the outer shell, and a power unit in electrical communication with the electrical wiring in order to provide an electrical charge through the electrical wiring.

In further embodiments of a fluid induction heating system, the apparatus may be in fluid communication with a fluid source such that a fluid is passed through the fluid chamber. The electrical wiring may be coiled around the outer shell. The fluid induction heating apparatus and the fluid source may form a closed system for circulating the fluid between the fluid chamber of the apparatus and the fluid source. The fluid source may be a residential water heater or a pool.

Referring now to the Figures, a fluid induction heating system 10 may include a fluid induction heating apparatus 100, an electrical system 200, and a housing 300. In accordance with embodiments more fully described herein, housing 300 may hold or secure heating apparatus 100 and electrical system 200. A fluid 12 may pass through heating apparatus 100, and electrical system 200 may be utilized with heating apparatus 100 so as to heat fluid 12 passing through apparatus 100 by induction.

Embodiments of a heating apparatus 100 may include an outer shell 102, an inner tube 104 securable within outer shell 102, and a pair of end caps 106 provided on each longitudinal end of outer shell 102. Electrical system 200 may generate an electromagnetic field through heating apparatus by charging an electrical coil 202 wrapped around outer shell 102. Inner tube 104 may include connection caps 108 attached to each longitudinal end of inner tube 104. Connection caps 108 may used to connect or secure inner tube 104 within outer shell 102. In the illustrated embodiment, one such connection application may be to splice the outer ends of connection caps 108 into a plurality of wings 109 which can be angled inwardly or outwardly. Outwardly angled caps 109 may be connected with an interior surface of outer shell 102 while inwardly angled caps 109 may facilitate securing connection caps 108 with inner tube 104. In one embodiment, both outer shell 102 and connection caps 108, including wings 109, may be made from copper, and wings 109 may be micro welded to the inner surface of outer shell 102 as well as an inner surface of inner tube 104 as shown in the figures and described herein. In further embodiments, inner tube 104 and connection caps 108 may be frozen, by exposure to liquid nitrogen for instance, than reheated into a place within chamber 110 thereby force fitting inner tube 104 within chamber 110.

The interior space or area of outer shell 102 may be a fluid flow chamber 110, with the area between outer shell 102 and inner tube 104 defined as the outer portion 111 of chamber 110 while the area inside inner tube 104 may be defined as the inner portion 112 of chamber 112. Fluid flow chamber 110 may be in fluid communication with a fluid source, such as a water tank used for residential or industrial applications. It should be appreciated that fluid may pass through both portions 111, 112 of chamber 110 thereby increasing the fluid contact surface area with inner tube 104, which is being heated by electromagnetic induction. It should also be appreciated that this design simultaneously increases the surface contact area between the heated inner tube 104 while removing numerous structural and electrical components from the fluid flow. In particular, all electrical components of electrical system 200 are outside chamber 110, inner portion 112 in completely unobstructed from fluid flow, and outer portion 111 is minimally obstructed by wings 109. Thus, the structural design of heating apparatus 100 optimizes the heat exchange to fluid 12 as well as minimizing fluid flow obstruction through chamber 110.

Inner tube 104 may be composed of an electrically conductive material capable of being quickly heated through electromagnetic induction. Outer shell 102 may be composed of an insulative material that does not heat as a result of electromagnetic induction from coil 202. In one embodiment, inner tube 104 may be composed of tungsten, which is an excellent heat generator for most residential and industrial heating applications because it is capable of being quickly heated to very high temperatures, reaching three thousand degrees Fahrenheit. In other embodiments, inner tube 104 may be composed of silica carbide or nickel. In some embodiments, outer shell 102, connection caps 108, or both may be composed of copper or ceramic. Copper may be beneficial due to its durability and anti-corrosive quality, which may be important depending on the environment system 10 is being used as well as the type of fluid 12 being heated.

A variety of types of fluid 12, and a variety of applications, are contemplated for use with the disclosed embodiments of heating system 10. Residential water heating units may benefit from system 10, such as water heaters. Commercial and industrial applications such as pasteurization and fermentation processes would also benefit from system 10. Larger bodies of water, such as a swimming pools, may also be heated using system 10. Any power generation system requiring steam could also benefit from system 10 as it is possible to produce both traditional and super-heated steam from fluid 12. Thus, turbines can be powered through the disclosed heating system. In this regarding, heating component 100, and more particular fluid chamber 110, may be in fluid communication with a fluid source and fluid deposit point respectively connected with to housing 300. In some applications, this may be a closed fluid system providing the heating, cooling, and re-heating of fluid 12 in a closed loop. Another closed loop application may be heating as for solar thermal farms and molten sodium reactors or storage. Further applications for embodiments of the system 10 may include desalination of water.

Electrical system 200 may include a power unit 204, which may include an inverter and a regulator, in electrical communication with the induction coil 202. An electronic control unit (ECU) 206 may also be provided to control the electrical system 200. In one embodiment for smaller, industrial applications, an efficient heating system 10 may be operated by generating between a 10 A and 100 A current through induction coil 202 with a 48V power source. Testing and trials performed with reduced to practice prototypes demonstrate that this embodiment would effectively replace a standard, single family home water heater, thereby saving the home owner significantly on power consumption.

The descriptions set forth above are meant to be illustrative and not limiting. Various modifications to the disclosed embodiments, in addition to those described herein, will be apparent to those skilled in the art from the foregoing description. Such modifications are also intended to fall within the scope of the concepts described herein. The disclosures of each patent, patent application, and publication cited or described in this document are hereby incorporated herein by reference, in their entireties.

The foregoing description of possible implementations consistent with the present disclosure does not represent a comprehensive list of all such implementations or all variations of the implementations described. The description of some implementations should not be construed as an intent to exclude other implementations described. For example, artisans will understand how to implement the disclosed embodiments in many other ways, using equivalents and alternatives that do not depart from the scope of the disclosure. Moreover, unless indicated to the contrary in the preceding description, no particular component described in the implementations is essential to the invention. It is thus intended that the embodiments disclosed in the specification be considered illustrative, with a true scope and spirit of invention being indicated by the following claims.

What is claimed:

1. A fluid induction heating apparatus comprising:
an outer shell with the interior of the outer shell defining a fluid chamber; and
an inner tube secured within the fluid chamber, the area between the inner tube and the outer shell defining an outer portion of the fluid chamber, and the area within the inner tube defining an inner portion of the fluid chamber,
wherein at least a portion of the inner tube is composed of a conductive material.

2. The apparatus of claim 1, further comprising a pair of connection caps each provided at a longitudinal end of the inner tube, each connection cap mutually connected with an inner surface of the outer shell as well as an outer surface of the inner tube.

3. The apparatus of claim 2, wherein each connection cap includes a plurality of wings, at least one wing of the plurality of wings is angled inwardly and connected with the inner tube, and at least one wing of the plurality of wings is angled outwardly and connected with the outer shell.

4. The apparatus of claim 1 further comprising a pair of end caps each provided at a longitudinal end of the outer shell.

5. The apparatus of claim 1, wherein the outer shell is composed of an insulative material.

6. The apparatus of claim 2, wherein the connection caps are also composed of the insulative material.

7. The apparatus of claim 6, wherein the insulative material is copper.

8. The apparatus of any of claim 1, wherein the conductive material is tungsten.

9. A fluid induction heating system comprising:
a fluid induction heating apparatus, comprising
an outer shell with the interior of the outer shell defining a fluid chamber, and
an inner tube secured within the fluid chamber, the area between the inner tube and the outer shell defining an outer portion of the fluid chamber, and the area within the inner tube defining an inner portion of the fluid chamber,
wherein at least a portion of the inner tube is composed of a conductive material; and
an electrical system 200 comprising
electrical wiring provided outside the outer shell, and
a power unit in electrical communication with the electrical wiring in order to provide an electrical charge through the electrical wiring.

10. The system of claim 9, wherein the fluid induction heating apparatus is in fluid communication with a fluid source such that a fluid is passed through the fluid chamber.

11. The system of claim 9, wherein the electrical wiring is coiled around the outer shell.

12. The system of claim 10, wherein the fluid induction heating apparatus and the fluid source form a closed system for circulating the fluid between the fluid chamber of the apparatus and the fluid source.

13. The system of claim 12, wherein the fluid source is a residential water heater or a pool.

14. The system of claim 9, wherein the apparatus further comprises a pair of connection caps each provided at a longitudinal end of the inner tube, each connection cap mutually connected with an inner surface of the outer shell as well as an outer surface of the inner tube.

15. The system of claim 14, each connection cap includes a plurality of wings, at least one wing of the plurality of wings is angled inwardly and connected with the inner tube, and at least one wing of the plurality of wings is angled outwardly and connected with the outer shell.

16. The system of claim 9, wherein the apparatus further comprises a pair of end caps each provided at a longitudinal end of the outer shell.

17. The system of claim 9, the outer shell is composed of an insulative material.

18. The system of claim 17, wherein the connection caps are also composed of the insulative material.

19. The system of claim 18, wherein the insulative material is copper.

20. The system of claim 9, wherein the conductive material is tungsten.
